(19) United States
(12) Patent Application Publication
(10) Pub. No.: US 2020/0177600 A1
(43) Pub. Date: Jun. 4, 2020

(54) Method and Apparatus for Granting Network Permission to Terminal, and Device

(71) Applicant: Huawei Technologies Co., Ltd., Shenzhen (CN)

(72) Inventors: Yibin Xu, Nanjing (CN); Donghui Wang, Nanjing (CN); Rong Yang, Nanjing (CN)

(21) Appl. No.: 16/786,568

(22) Filed: Feb. 10, 2020

Related U.S. Application Data
(63) Continuation of application No. PCT/CN2018/098909, filed on Aug. 6, 2018.

(30) Foreign Application Priority Data
Aug. 10, 2017 (CN) 201710681839.X

(51) Int. Cl. H04L 29/06; H04W 12/06; H04W 12/00; H04L 29/08

(52) U.S. Cl. CPC H04L 63/102; H04L 63/0876; H04L 67/02; H04W 12/00512; H04W 12/06

(57) ABSTRACT

A method and an apparatus for granting network permission to a terminal include receiving, by an authentication device, a network permission request packet sent by a terminal, granting, by the authentication device, first network permission to the terminal receiving, by the authentication device, a first authentication failure message sent by a server after granting the first network permission to the terminal, and withdrawing, by the authentication device, the first network permission of the terminal based on the first authentication failure message. Therefore, the authentication device can grant the network permission to the terminal before receiving an authentication result sent by the server, and withdraw the network permission in time when receiving the first authentication failure message sent by the server.

### CROSS-REFERENCE TO RELATED APPLICATIONS

This application is a continuation of International Patent Application No. PCT/CN2018/098909 filed on Aug. 6, 2018, which claims priority to Chinese Patent Application No. 201710681839.X filed on Aug. 10, 2017, both of which are hereby incorporated by reference in their entireties.

### TECHNICAL FIELD

This application relates to the field of communications technologies, and in particular, to a method and an apparatus for granting network permission to a terminal, and a device.

### BACKGROUND

In an authentication solution, a server attempts to authenticate a terminal based on an authentication request message sent by the terminal, and when the terminal is authenticated, the server sends an authentication success message to an authentication device. The authentication device grants network permission to the terminal based on the authentication success message.

As shown in FIG. 1, if the authentication device and the server are deployed across a wide area network (WAN), because the WAN is unstable, a packet loss may occur between the authentication device and the server. If the authentication success message sent by the server is lost, or a response message sent by the authentication device is lost, the server retransmits the authentication success message. A delay of the authentication success message prolongs a wait period of the terminal.

### SUMMARY

This application provides a method and an apparatus for granting network permission to a terminal, and a device, to resolve a problem of a long wait period of a terminal resulting from WAN instability.

According to a first aspect, this application provides a method for granting network permission to a terminal, including receiving, by an authentication device, a network permission request packet sent by a terminal, granting, by the authentication device, first network permission to the terminal receiving, by the authentication device, a first authentication failure message sent by a server after granting the first network permission to the terminal, and withdrawing, by the authentication device, the first network permission of the terminal based on the first authentication failure message. The first authentication failure message is sent when the server determines, based on a first authentication request message sent by the terminal, that the terminal fails to be authenticated.

Therefore, the authentication device can grant the network permission to the terminal before receiving an authentication result sent by the server to avoid a long wait period of the terminal resulting from WAN instability, and can withdraw the network permission in time when receiving the first authentication failure message sent by the server.

In a possible design, after granting the first network permission to the terminal, the authentication device receives a first authentication success message sent by the server, where the first authentication success message instructs the authentication device to grant second network permission to the terminal. The authentication device grants the second network permission to the terminal based on the first authentication success message. The first authentication success message is sent when the server determines, based on the first authentication request message sent by the terminal, that the terminal is authenticated, and the second network permission is broader than the first network permission.

Therefore, when the terminal is authenticated, the server may instruct the authentication device to grant broader network permission to the terminal.

In addition, when the first authentication success message does not include an instruction of granting the second network permission to the terminal, or when the first authentication success message instructs the authentication device to grant the second network permission to the terminal and the second network permission is equal to the first network permission, the authentication device may not perform any action, that is, maintain the current network permission of the terminal. The authentication device may alternatively confirm the current network permission of the terminal. For example, the first network permission is temporary network permission having a time limit, and the authentication device makes the current network permission of the terminal permanent based on the first authentication success message.

In a possible design, the network permission request packet is a network access packet, a source Media Access Control (MAC) address in the network access packet is a MAC address of the terminal, and before the authentication device grants the first network permission to the terminal, the authentication device sends the MAC address of the terminal to the server. The authentication device receives a second authentication success message sent by the server, where the second authentication success message is determined by the server based on the MAC address of the terminal and reputation data of the terminal, and the second authentication success message instructs the authentication device to grant the first network permission to the terminal.

The authentication device may send the MAC address of the terminal to the server in the following two manners. The authentication device may add the MAC address of the terminal to the network permission request packet sent by the terminal to the server, and then send the packet to the server. Alternatively, the authentication device directly forwards, to the server, the network permission request packet sent by the terminal to the server, and then sends a separate packet including the MAC address of the terminal to the server.

The terminal is unaware of an authentication process that is performed based on the reputation data of the terminal, and therefore, a wait period of the terminal is not prolonged. The method can assist the authentication device in determining whether to grant the first network permission to the terminal.

According to a second aspect, this application provides a method for granting network permission to a terminal, including receiving, by a server, a first authentication request, where the first authentication request is used to request to authenticate a terminal, sending, by the server, a first authentication success message to an authentication device, and before receiving a response message that is sent by the authentication device for the first authentication success message, sending, by the server, an authentication success indication message to the terminal.

In a captive portal authentication scenario, after granting network permission to the terminal, the authentication device sends a response message for an authentication success message to the server. After receiving the response message, the server sends an authentication success indication message to the terminal. A user learns, based on the authentication success indication message received by the terminal, that the terminal is granted the network permission, and can access a network. In this application, the authentication device grants first network permission to the terminal before receiving the first authentication success message. Therefore, when the terminal is authenticated, the server directly sends the authentication success indication to the terminal without waiting for the response message that is sent by the authentication device for the first authentication success message. This can avoid an excessively long wait period of the terminal and poor user experience caused when the response message for the authentication success message is lost, and shorten a wait period of the terminal.

In a possible design, the server receives a MAC address of the terminal sent by the authentication device, and the server sends a second authentication success message to the authentication device, where the second authentication success message is determined by the server based on the MAC address of the terminal and reputation data of the terminal, and the second authentication success message instructs the authentication device to grant first network permission to the terminal.

Therefore, the terminal is unaware of a process of authenticating the terminal based on the reputation data of the terminal. During captive portal authentication, an authentication page is pushed to the terminal, and a user is required to enter an authentication token. As a result, a captive portal authentication process occupies a long time. The process of authenticating the terminal based on the reputation data of the terminal is automatically performed independently of captive portal authentication. Therefore, the wait period of the terminal and a time occupied by the entire captive portal authentication process are not prolonged. The authentication process is applicable to the captive portal authentication scenario, and can assist the authentication device in determining whether to grant the first network permission to the terminal.

According to a third aspect, this application provides an apparatus for granting network permission to a terminal, including a receiving unit and a processing unit. The receiving unit is configured to receive a network permission request packet sent by a terminal. The processing unit is configured to grant first network permission to the terminal. The receiving unit is further configured to receive a first authentication failure message sent by a server after the first network permission is granted to the terminal, where the first authentication failure message is sent when the server determines, based on a first authentication request message sent by the terminal, that the terminal fails to be authenticated. The processing unit is further configured to withdraw the first network permission of the terminal based on the first authentication failure message.

In a possible design, after the first network permission is granted to the terminal, the receiving unit is further configured to receive a first authentication success message sent by the server, where the first authentication success message is sent when the server determines, based on the first authentication request message sent by the terminal, that the terminal is authenticated, the first authentication success message instructs the authentication device to grant second network permission to the terminal, and the second network permission is broader than the first network permission. The processing unit is further configured to grant the second network permission to the terminal based on the first authentication success message.

In a possible design, the network permission request packet is a network access packet, a source MAC address in the network access packet is a MAC address of the terminal, and before the authentication device grants the first network permission to the terminal, the apparatus further includes a sending unit configured to send the MAC address of the terminal to the server, where the receiving unit is further configured to receive a second authentication success message sent by the server, where the second authentication success message is determined by the server based on the MAC address of the terminal and reputation data of the terminal, and the second authentication success message instructs the authentication device to grant the first network permission to the terminal.

According to a fourth aspect, this application provides an apparatus for granting network permission to a terminal, including a receiving unit and a sending unit. The receiving unit is configured to receive a first authentication request, where the first authentication request is used to request to authenticate a terminal. The sending unit is configured to send a first authentication success message to an authentication device. The sending unit is further configured to send an authentication success indication message to the terminal before a response message that is sent by the authentication device for the first authentication success message is received.

In a possible design, the apparatus further includes the receiving unit configured to receive a MAC address of the terminal sent by the authentication device, and the sending unit is configured to send a second authentication success message to the authentication device, where the second authentication success message is determined by the server based on the MAC address of the terminal and reputation data of the terminal, and the second authentication success message instructs the authentication device to grant first network permission to the terminal.

According to a fifth aspect, this application further provides an authentication device, including a processor and a communications interface. The communications interface is configured to communicate with another device. The authentication device further includes a memory. The memory is configured to store a program, an instruction, and the like. The processor is configured to implement the method in the first aspect.

According to a sixth aspect, this application further provides a server, including a processor and a communications interface. The communications interface is configured to communicate with another device. The server further includes a memory. The memory is configured to store a program, an instruction, and the like. The processor is configured to implement the method in the second aspect.

According to a seventh aspect, this application further provides a first computer storage medium, storing a computer executable instruction. The computer executable instruction is used to perform the method in the first aspect of this application.

According to an eighth aspect, this application further provides a second computer storage medium, storing a computer executable instruction. The computer executable instruction is used to perform the method in the second aspect of this application.

According to a ninth aspect, this application further provides a first computer program product. The computer program product includes a computer program stored in the first computer storage medium. The computer program includes a program instruction. When the program instruction is executed by a computer, the computer performs the method in the first aspect of this application.

According to a tenth aspect, this application further provides a second computer program product. The computer program product includes a computer program stored in the second computer storage medium. The computer program includes a program instruction. When the program instruction is executed by a computer, the computer performs the method in the second aspect of this application.

### BRIEF DESCRIPTION OF DRAWINGS

FIG. 1 is a schematic diagram showing that an authentication device and an authentication server are deployed across a WAN;

FIG. 2A and FIG. 2B are a flowchart of granting network permission to a terminal according to an embodiment of this application;

FIG. 3 is a flowchart of authenticating a terminal based on reputation data of the terminal according to an embodiment of this application;

FIG. 4A and FIG. 4B are a flowchart of granting network permission to a terminal according to an embodiment of this application;

FIG. 5A and FIG. 5B are a flowchart of granting network permission to a terminal based on a captive portal authentication scenario according to an embodiment of this application;

FIG. 6A and FIG. 6B are a flowchart of granting network permission to a terminal based on a captive portal authentication scenario according to an embodiment of this application;

FIG. 7 is a schematic diagram of an apparatus for granting network permission to a terminal according to an embodiment of this application;

FIG. 8 is a schematic diagram of an apparatus for granting network permission to a terminal according to an embodiment of this application;

FIG. 9 is a schematic structural diagram of an authentication device according to an embodiment of this application; and

FIG. 10 is a schematic structural diagram of an authentication server according to an embodiment of this application.

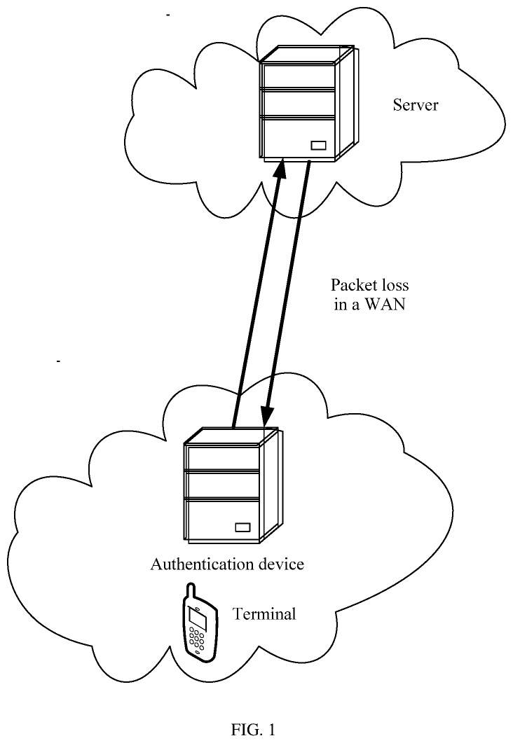

### DESCRIPTION OF EMBODIMENTS

The following describes the embodiments of this application with reference to the accompanying drawings.

This application is applicable to a captive portal authentication scenario, an Extensible Authentication Protocol (EAP) authentication scenario, a Remote Authentication Dial In User Service (RADIUS) protocol authentication scenario, a Diameter protocol authentication scenario, a Kerberos protocol authentication scenario, and the like.

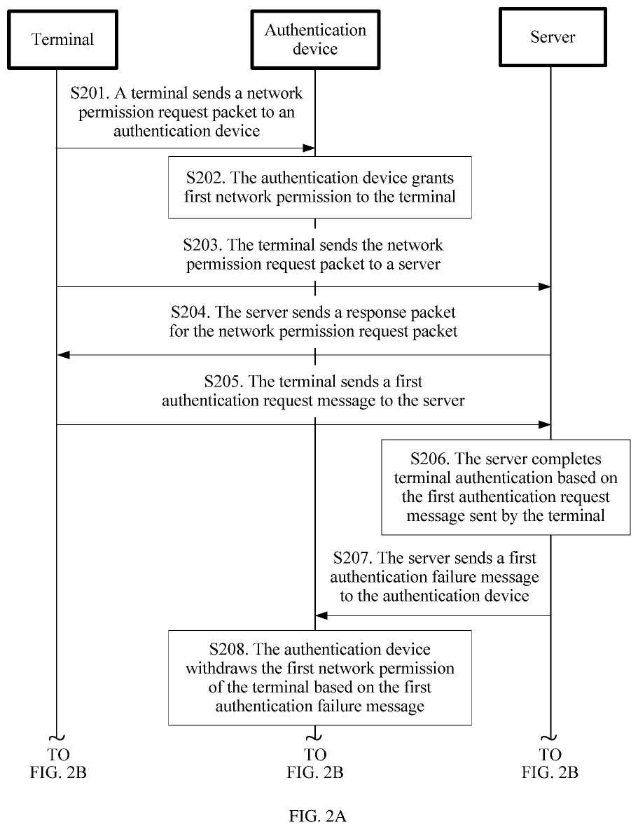

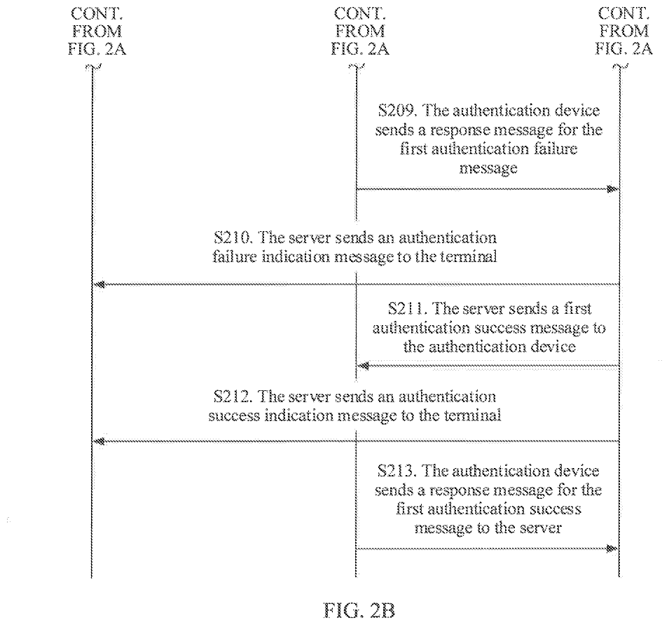

Referring to FIG. 2A and FIG. 2B, this application provides a method for granting network permission to a terminal. A captive portal authentication scenario is used as an example, and the method includes the following steps.

In the captive portal authentication scenario, a server may be one physical server, and the server includes a function of a portal server and a function of an authentication server, or the server may include two separate physical servers, a portal server and an authentication server.

Step S201. A terminal sends a network permission request packet to an authentication device.

The network permission request packet is a network access packet, and a source MAC address in the network access packet is a MAC address of the terminal.

For example, the network access packet may be a Hyper Text Transfer Protocol (HTTP)/HTTP Secure (HTTPS) packet, or an Internet Protocol (IP) packet.

Step S202. The authentication device grants first network permission to the terminal.

Optionally, the first network permission may be temporary network permission having a time limit.

Optionally, after receiving the network permission request packet sent by the terminal, the authentication device sends a response packet for the network permission request packet to the terminal. For example, when the server is one physical server, and the server includes the function of the portal server and the function of the authentication server, the response packet for the HTTP/HTTPS packet includes a uniform resource locator (URL) of the server. When the server may include two separate physical servers, the portal server and the authentication server, the response packet for the HTTP/HTTPS packet includes a URL of the portal server.

Step S203. The terminal sends a network permission request packet to the server.

A destination address of the HTTP/HTTPS packet in step S201 is an address of a website that the terminal requests to access.

When the server is one physical server, and the server includes the function of the portal server and the function of the authentication server, the terminal may send the network permission request packet to the server based on the URL of the server included in the received response packet for the HTTP/HTTPS packet. Therefore, a destination address of a HTTP/HTTPS in step S203 is an address of the server.

When the server includes two separate physical servers the portal server and the authentication server, the terminal may send the network permission request packet to the portal server based on the URL of the portal server included in the received response packet for the HTTP/HTTPS packet. Therefore, a destination address of the HTTP/HTTPS in step S203 is an address of the portal server.

Optionally, step S203 may be performed before step S202.

Step S204. The server sends a response packet for the network permission request packet.

That the authentication server sends the response packet for the network permission request packet means that the authentication server pushes a login authentication page to the terminal.

Step S205. The terminal sends a first authentication request message to the server.

A user enters an authentication token (for example, a user name and a password) based on the authentication page pushed by the server.

The terminal sends the first authentication request message including the authentication token to the authentication server.

Step S206. The server completes terminal authentication based on the first authentication request message sent by the terminal, and performs step S207 if the server determines, based on the first authentication request message sent by the terminal, that the terminal fails to be authenticated, or performs step S211 if the server determines, based on the first authentication request message sent by the terminal, that the terminal is authenticated. When the server includes two separate physical servers, the portal server and the authentication server, the authentication server performs an authentication-related step.

Step S207. The server sends a first authentication failure message to the authentication device.

Step S208. The authentication device withdraws the first network permission of the terminal based on the first authentication failure message.

Therefore, when the terminal fails to be authenticated, the authentication device may withdraw the first network permission of the terminal in time based on the first authentication failure message.

Step S209. The authentication device sends a response message for the first authentication failure message to the server.

Step S210. The server sends an authentication failure indication message to the terminal.

Optionally, step S209 may be performed before step S208.

The process ends.

Step S211. The server sends a first authentication success message to the authentication device.

In addition, optionally, the first authentication success message instructs the authentication device to grant second network permission to the terminal, and the second network permission is broader than or equal to the first network permission.

When the second network permission is broader than the first network permission, the authentication device grants the second network permission to the terminal based on the first authentication success message, and in this case, the terminal obtains broader network permission.

When the first authentication success message does not include an instruction of granting the second network permission to the terminal, or when the first authentication success message instructs the authentication device to grant the second network permission to the terminal and the second network permission is equal to the first network permission, the authentication device may not perform any action, that is, maintain the current network permission of the terminal. The authentication device may alternatively confirm the current network permission of the terminal. For example, the first network permission is temporary network permission having a time limit, and the authentication device makes the current network permission of the terminal permanent based on the first authentication success message.

Step S212. The server sends an authentication success indication message to the terminal.

Optionally, the server may send the authentication success indication before receiving the response message that is sent by the authentication device for the first authentication success message (for example, when sending the first authentication success message). The authentication device grants the first network permission to the terminal before receiving the first authentication success message. Therefore, when the terminal is authenticated, the server directly sends the authentication success indication to the terminal without waiting for the response message that is sent by the authentication device for the first authentication success message. This can avoid an excessively long wait period of the terminal and poor user experience caused by a packet loss when the authentication device and the server are deployed across a WAN, and shorten a wait period of the terminal. A basic idea of this embodiment of this application includes that a packet of the terminal is permitted first, that is, network permission is granted to the terminal first, and if authentication fails, the network permission of the terminal is withdrawn in time.

Step S213. The authentication device sends a response message for the first authentication success message to the server.

The process ends.

In the captive portal authentication scenario, a user needs to enter information such as a user name and a password based on an authentication page pushed by a server, and an entire captive portal authentication process occupies a relatively long time. Therefore, in a possible design, this application further provides a method for authenticating a terminal based on reputation data of the terminal. Before an authentication device obtains a result of authenticating a terminal by a server, the server may authenticate the terminal based on reputation data of the terminal, and the authentication device determines whether to grant first network permission to the terminal. This method is applied to the captive portal authentication scenario, and may be performed before step S202 in the foregoing embodiment, and used as a supplement and assistance to the authentication process in FIG. 2A and FIG. 2B.

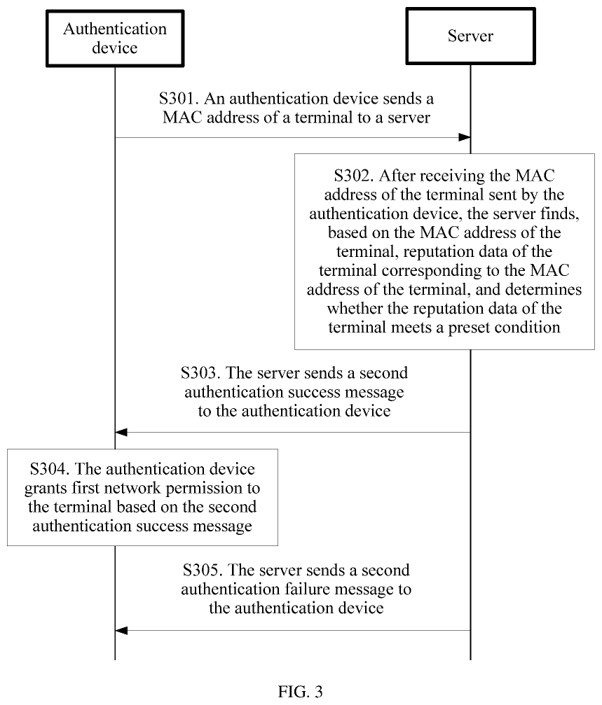

As shown in FIG. 3, a basic process of the authentication process is as follows.

Step S301. The authentication device sends a MAC address of the terminal to the server.

When the terminal sends a network permission request packet to the server, the network permission request packet needs to be forwarded by the authentication device. The authentication device may add the MAC address of the terminal to the network permission request packet, and then send the network permission request packet to the server. Alternatively, the authentication device directly forwards the network permission request packet to the server, and then sends a separate packet including the MAC address of the terminal to the server.

Step S302. After receiving the MAC address of the terminal sent by the authentication device, the server finds, based on the MAC address of the terminal, reputation data of the terminal corresponding to the MAC address of the terminal, determines whether the reputation data of the terminal meets a preset condition, and performs step S303 if the reputation data of the terminal meets the preset condition, or performs step S305 if the reputation data of the terminal does not meet the preset condition.

Optionally, the reputation data of the terminal includes but is not limited to at least one of a quantity of times of historical authentication success of the terminal, a ratio of the quantity of times of historical authentication success of the terminal to a total quantity of times of historical authentication of the terminal, or a credit rating of a user using the terminal.

Reputation data of a plurality of terminals may be stored in the server in advance, or obtained by the server from another device storing the reputation data of the plurality of terminals.

For example, the server determines the reputation data of the terminal based on the MAC address of the terminal. It is assumed that the reputation data of the terminal is the quantity of times of historical authentication success of the terminal, and the preset condition is that a quantity of times of historical authentication success is greater than a first threshold. When the quantity of times of historical authentication success of the terminal is greater than the first threshold, the server determines that the reputation data of the terminal meets the preset condition.

For another example, the server determines the reputation data of the terminal based on the MAC address of the terminal. For example, the reputation data of the terminal is the credit rating of the user using the terminal. It is assumed that the preset condition is that a credit level of credit data is higher than a preset rating. When a credit level of the credit rating of the user using the terminal is higher than the preset rating, the server determines that the reputation data of the terminal meets the preset condition.

The types and the corresponding preset conditions of the reputation data are examples, and are not used as limitation to this application.

Step S303. The server sends a second authentication success message to the authentication device.

The second authentication success message is used to instruct the authentication device to grant first network permission to the terminal.

Optionally, the second authentication success message includes an identifier of the first network permission. Alternatively, the second authentication success message does not include an identifier of the first network permission, and instead, the server and the authentication device are agreed that the authentication device can grant the first network permission to the terminal when the authentication device receives the second authentication success message.

Step S304. The authentication device grants first network permission to the terminal based on the second authentication success message.

The process ends.

Step S305. The server sends a second authentication failure message to the authentication device.

The second authentication failure message is used to instruct the authentication device temporarily not to grant the first network permission to the terminal.

The process ends.

The terminal is unaware of the process of authenticating the terminal based on the reputation data of the terminal. During captive portal authentication, an authentication page is pushed to the terminal, and a user is required to enter an authentication token. As a result, a captive portal authentication process occupies a long time. The process of authenticating the terminal based on the reputation data of the terminal is automatically performed independently of captive portal authentication. Therefore, a wait period of the terminal and a time occupied by the entire captive portal authentication process are not prolonged. The authentication process is applicable to the captive portal authentication scenario, and can assist the authentication device in determining whether to grant the first network permission to the terminal.

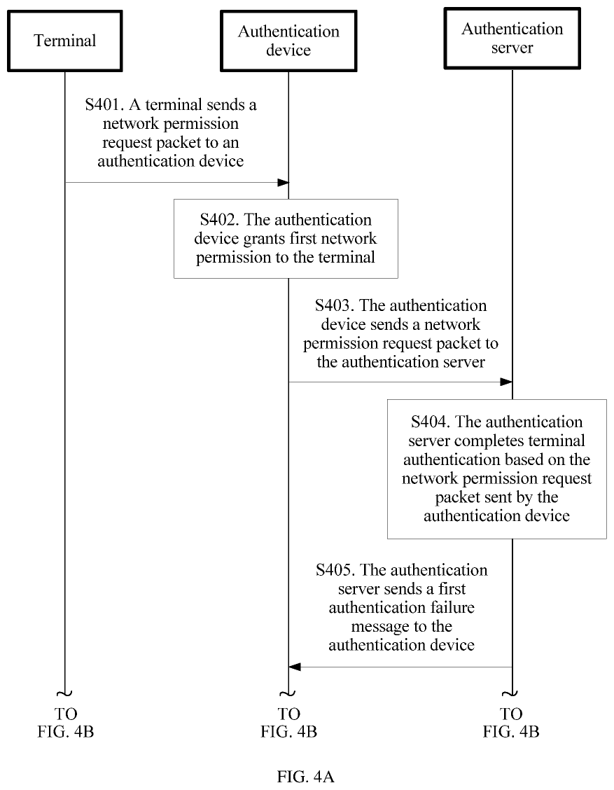

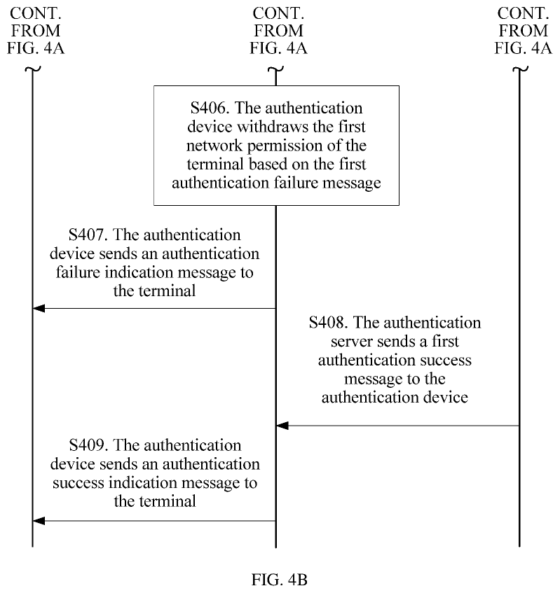

Referring to FIG. 4A and FIG. 4B, this application provides a method for granting network permission to a terminal. An EAP authentication scenario is used as an example, and the method includes the following steps.

In the EAP authentication scenario, a server may be an authentication server.

Step S401. A terminal sends a network permission request packet to an authentication device.

For example, the network permission request packet may be an EAP start packet, or an EAP response packet. The network permission request packet may include an authentication token (for example, a digital certificate) of the terminal.

Step S402. The authentication device grants first network permission to the terminal.

Optionally, the first network permission may be temporary network permission having a time limit.

Step S403. The authentication device sends a network permission request packet to the authentication server.

For example, the network permission request packet is a RADIUS access-request packet. The network permission request packet may include the authentication token of the terminal.

Step S404. The authentication server completes terminal authentication based on the network permission request packet sent by the authentication device, and performs step S405 if the terminal fails to be authenticated, or performs step S408 if the terminal is authenticated.

Step S405. The authentication server sends a first authentication failure message to the authentication device.

For example, the first authentication failure message is a RADIUS access-reject packet.

Step S406. The authentication device withdraws the first network permission of the terminal based on the first authentication failure message.

Step S407. The authentication device sends an authentication failure indication message to the terminal. For example, the authentication failure indication message is an EAP failure packet.

The process ends.

Step S408. The authentication server sends a first authentication success message to the authentication device.

For example, the first authentication success message is a RADIUS access-accept packet.

If the first network permission is the temporary network permission having a time limit, the authentication device may further make the current network permission of the terminal permanent based on the first authentication success message.

Step S409. The authentication device sends an authentication success indication message to the terminal. For example, the authentication success indication message is an EAP success packet.

The process ends.

Therefore, the authentication device can grant the network permission to the terminal before receiving an authentication result sent by the authentication server, to avoid a long wait period of the terminal resulting from WAN instability, and can withdraw the network permission in time when receiving the first authentication failure message sent by the authentication server.

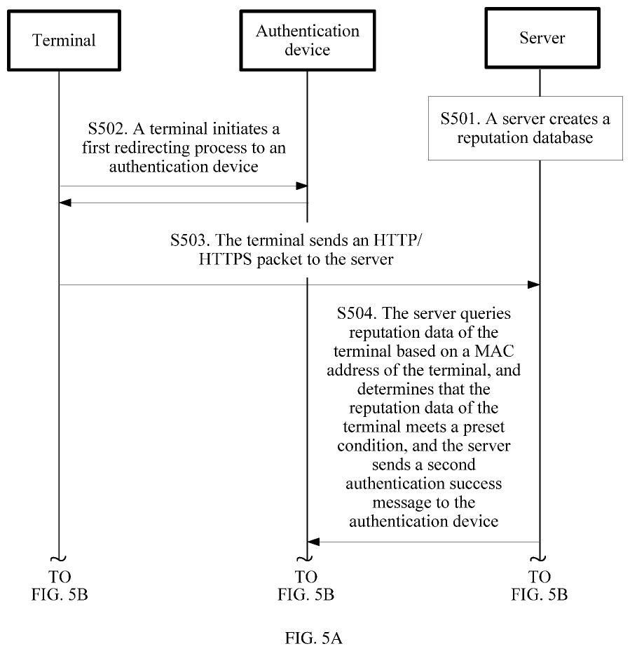

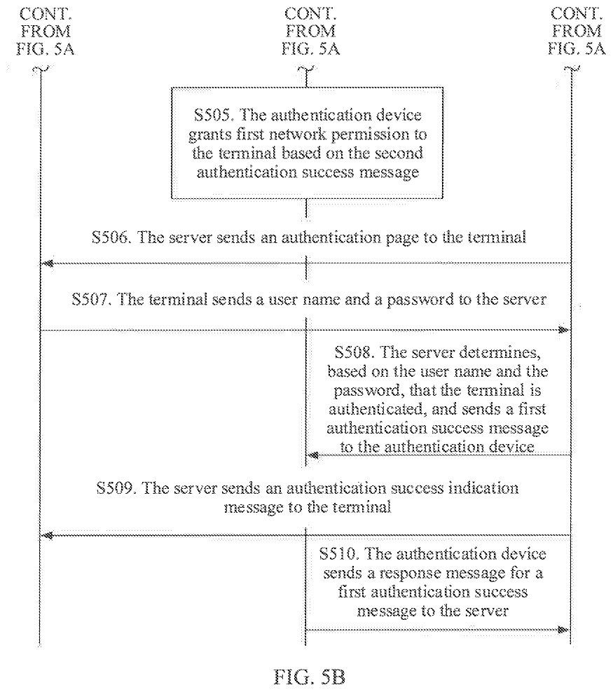

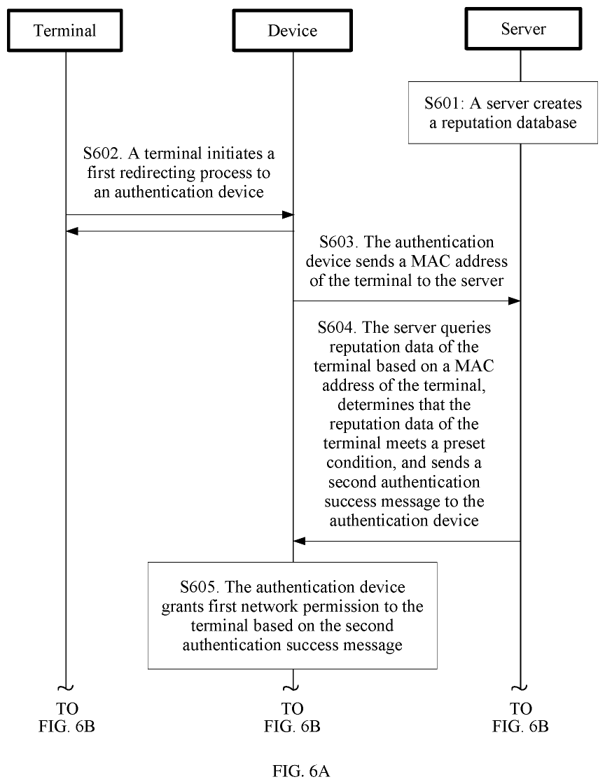

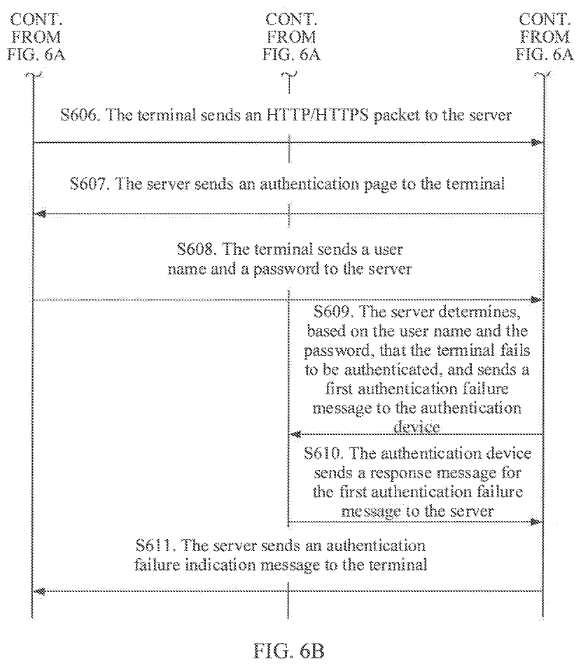

As shown in FIG. 5A, FIG. 5B, FIG. 6A, and FIG. 6B, the following describes in detail the embodiments of this application with reference to a captive portal authentication scenario.

FIG. 5A and FIG. 5B are a flowchart of granting network permission to a terminal based on the captive portal authentication scenario.

Step S501. A server creates a reputation database.

The reputation database includes reputation data of a plurality of terminals, and reputation data of each terminal is bound with a MAC address of the corresponding terminal.

Step S502. A terminal initiates a first redirecting process to an authentication device.

The terminal sends an HTTP/HTTPS packet to an authentication device, and the authentication device sends a response message for the HTTP/HTTPS packet. A source MAC address in the HTTP/HTTPS packet is a MAC address of the terminal. The response message for the HTTP/HTTPS packet includes a URL of the server.

The HTTP/HTTPS packet sent by the terminal to the authentication device is equivalent to step S201 in the embodiment of FIG. 2A and FIG. 2B.

Step S503. The terminal sends an HTTP/HTTPS packet to the server.

The HTTP/HTTPS packet sent by the terminal to the server needs to be forwarded by the authentication device, and the authentication device adds the MAC address of the terminal to the HTTP/HTTPS packet.

The HTTP/HTTPS packet sent by the terminal to the server is equivalent to step S203 in the embodiment of FIG. 2A and FIG. 2B.

Step S504. The server queries reputation data of the terminal based on a MAC address of the terminal, and determines that the reputation data of the terminal meets a preset condition, and the server sends a second authentication success message to the authentication device.

Step S505. The authentication device grants first network permission to the terminal based on the second authentication success message.

In addition, the authentication device further needs to send a response message for the second authentication success message to the server, and this is not shown in FIG. 4A and FIG. 4B. If the server does not receive the response message that is sent by the authentication device for the second authentication success message, the server needs to retransmit the second authentication success message. However, even if the server needs to retransmit the second authentication success message, no impact is caused on performing step S506 by the server. The terminal is unaware of a process of authenticating the terminal by the server based on the reputation data of the terminal, and therefore, no impact is caused on the terminal authentication process by the server shown in FIG. 2A and FIG. 2B.

Step S506. The server sends an authentication page to the terminal.

Step S507. The terminal sends a user name and a password to the server.

Step S508. The server determines, based on the user name and the password, that the terminal is authenticated, and sends a first authentication success message to the authentication device.

Step S509. The server sends an authentication success indication message to the terminal.

Step S510. The authentication device sends a response message for the first authentication success message to the server.

The authentication device grants the first network permission to the terminal before receiving the first authentication success message. Therefore, when the terminal is authenticated, the server directly sends the authentication success indication to the terminal without waiting for the response message that is sent by the authentication device for the first authentication success message. This can shorten a wait period of the terminal, and avoid an excessively long wait period of the terminal caused when the response message for the authentication success message is lost.

FIG. 6A and FIG. 6B are a flowchart of granting network permission to a terminal based on the captive portal authentication scenario.

Step S601. A server creates a reputation database.

The reputation database includes reputation data of a plurality of terminals, and reputation data of each terminal is bound with a MAC address of the corresponding terminal.

Step S602. A terminal initiates a first redirecting process to an authentication device.

The terminal sends an HTTP/HTTPS packet to the authentication device, and the authentication device sends a response message for the HTTP/HTTPS packet. A source MAC address in the HTTP/HTTPS packet is a MAC address of the terminal. The response message for the HTTP/HTTPS packet includes a URL of the server.

The HTTP/HTTPS packet sent by the terminal to the authentication device is equivalent to step S201 in the embodiment of FIG. 2A and FIG. 2B.

Step S603. The authentication device sends a MAC address of the terminal to the server.

The authentication device obtains the MAC address of the terminal based on the source MAC address in the HTTP/HTTPS packet.

Step S604. The server queries reputation data of the terminal based on the MAC address of the terminal, determines that the reputation data of the terminal meets a preset condition, and sends a second authentication success message to the authentication device.

Step S605. The authentication device grants first network permission to the terminal based on the second authentication success message.

Step S606. The terminal sends an HTTP/HTTPS packet to the server.

The HTTP/HTTPS packet sent by the terminal to the server is equivalent to step S203 in the embodiment of FIG. 2A and FIG. 2B.

Step S607. The server sends an authentication page to the terminal.

Step S608. The terminal sends a user name and a password to the server.

Step S609. The server determines, based on the user name and the password, that the terminal fails to be authenticated, and sends a first authentication failure message to the authentication device.

Step S610. The authentication device sends a response message for the first authentication failure message to the server.

The authentication device withdraws the first network permission of the terminal based on the first authentication failure message, and then sends the response message for the first authentication failure message to the server.

Step S611. The server sends an authentication failure indication message to the terminal.

Therefore, the authentication device may first grant the network permission to the terminal based on a result of authentication performed based on the reputation data of the terminal, and subsequently, if the server notifies the authentication device that the terminal fails to be authenticated, the authentication device withdraws the network permission of the terminal in time.

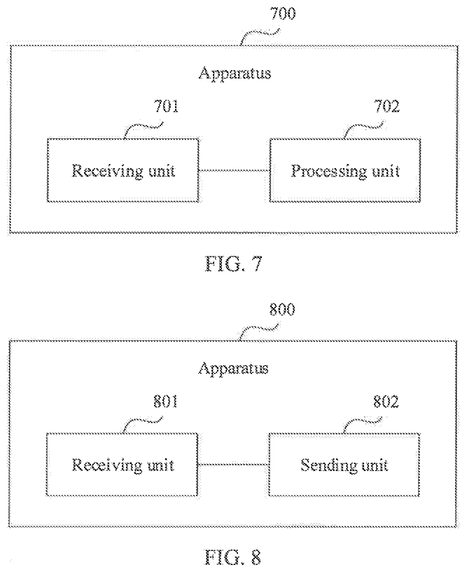

Based on the foregoing embodiments, this application further provides, in FIG. 7, an apparatus 700 for granting network permission to a terminal, to implement functions of the authentication device in FIG. 2A, FIG. 2B, FIG. 4A, and FIG. 4B. The apparatus 700 includes a receiving unit 701 and a processing unit 702.

The receiving unit 701 is configured to receive a network permission request packet sent by a terminal.

The processing unit 702 is configured to grant first network permission to the terminal.

The receiving unit 701 is further configured to receive a first authentication failure message sent by an authentication server after the first network permission is granted to the terminal, where the first authentication failure message is sent when the authentication server determines, based on a first authentication request message sent by the terminal, that the terminal fails to be authenticated.

The processing unit 702 is further configured to withdraw the first network permission of the terminal based on the first authentication failure message.

For details, refer to the method embodiments of FIG. 2A, FIG. 2B, FIG. 4A, and FIG. 4B, and details are not described in this application again.

Based on the foregoing embodiments, this application further provides, in FIG. 8, an apparatus 800 for granting network permission to a terminal, to implement functions of the server in FIG. 2A and FIG. 2B. The apparatus 800 includes a receiving unit 801 and a sending unit 802.

The receiving unit 801 is configured to receive a first authentication request, where the first authentication request is used to request to authenticate a terminal.

The sending unit 802 is configured to send a first authentication success message to an authentication device.

The sending unit 802 is further configured to send an authentication success indication message to the terminal before a response message that is sent by the authentication device for the first authentication success message is received.

For details, refer to the method embodiment of FIG. 2A and FIG. 2B, and details are not described in this application again.

It should be understood that division of the units of the terminal and the network device is merely logical function division. In actual implementation, all or some of the units may be integrated into one physical entity, or the units may be physically separate. In addition, the units all may be implemented by software invoked by a processing element, or all may be implemented by hardware, or some units may be implemented by software invoked by a processing element, and some units are implemented by hardware. For example, the processing unit may be a separately disposed processing element, may be implemented by being integrated into a chip, or may be stored in a memory in a form of a program, and a processing element invokes the program and executes the function of the unit. Implementations of the other units are similar. In addition, all or some of the units may be integrated together, or may be implemented independently. The processing element may be an integrated circuit, and have a signal processing capability. In an implementation process, steps in the foregoing methods or the foregoing units may be implemented using a hardware integrated logical circuit in the processing element, or using instructions in a form of software. For example, the units may be one or more integrated circuits configured to implement the foregoing methods, for example, one or more application-specific integrated circuits (ASIC), or one or more digital signal processors (DSP), or one or more field-programmable gate arrays (FPGA). For another example, when one of the foregoing units is implemented by the processing element invoking a program, the processing element may be a general-purpose processor, for example, a central processing unit (CPU) or another processor that can invoke the program. For another example, the units may be integrated together, and implemented in a form of a system on chip (SOC).

Based on the foregoing embodiments, this application further provides, in FIG. 9, an authentication device 900, having functions of the authentication device in FIG. 2A, FIG. 2B, FIG. 4A, and FIG. 4B. Referring to FIG. 9, the authentication device 900 includes a communications interface 901 and a processor 902. The communications interface 901 is configured to communicate with another device. Optionally, the authentication device 900 further includes a memory (not shown).

The communications interface 901 may include an interface configured to communicate with another device. For example, the communications interface 901 may include an interface configured to communicate with a terminal, an interface configured to communicate with a server, and another interface. The interface may be a wired interface, a wireless interface, or a combination thereof. The wired interface, for example, may be an Ethernet interface. The Ethernet interface may be an optical interface, an electrical interface, or a combination thereof. The wireless interface, for example, may be a wireless local area network (WLAN) interface, a cellular network interface, or a combination thereof.

The processor 902 may be a CPU, or a combination of a CPU and a forwarding chip.

The memory is configured to store a program, an instruction, and the like. Further, the program may include a program code, and the program code includes a computer operation instruction. The memory may include a random access memory (RAM), or may include a non-volatile memory, for example, at least one magnetic memory. The processor 902 executes the program, the instruction, and the like stored in the memory, to implement the functions of the authentication device in the method embodiments of FIG. 2A, FIG. 2B, FIG. 4A, and FIG. 4B.

A function of the receiving unit 701 in FIG. 7 is implemented using the communications interface 901, and a function of the processing unit 702 is implemented using the processor 902.

The processor 902 is configured to receive, through the communications interface 901, a network permission request packet sent by the terminal, grant first network permission to the terminal, after granting the first network permission to the terminal, receive, through the communications interface 901, a first authentication failure message sent by an authentication server, where the first authentication failure message is sent when the authentication server determines, based on a first authentication request message sent by the terminal, that the terminal fails to be authenticated, and withdraw the first network permission of the terminal based on the first authentication failure message.

For details, refer to the method embodiments of FIG. 2A, FIG. 2B, FIG. 4A, and FIG. 4B, and details are not described in this application again.

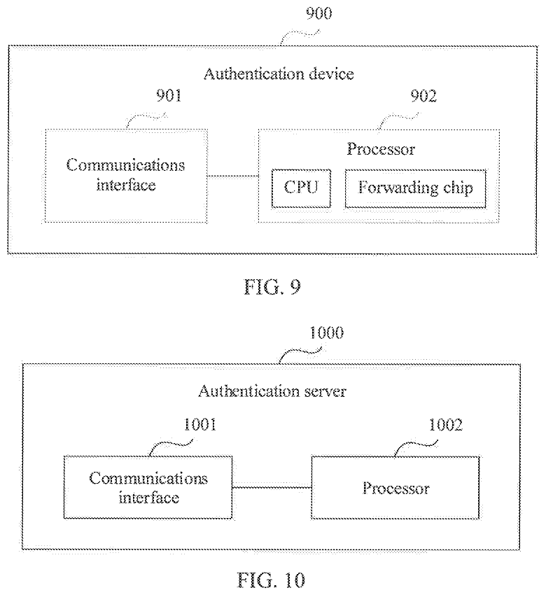

Based on the foregoing embodiments, this application further provides, in FIG. 10, an authentication server 1000, having functions of the server in FIG. 2A and FIG. 2B. Referring to FIG. 10, the server 1000 includes a communications interface 1001 and a processor 1002. The communications interface 1001 is configured to communicate with another device, and the server 1000 further includes a memory (not shown). Functions of the sending unit 802 and the receiving unit 801 in FIG. 8 are implemented using the communications interface 1001.

The communications interface 1001 may include an interface configured to communicate with another device. For example, the communications interface may include an interface configured to communicate with an authentication device. The interface may be a wired interface, a wireless interface, or a combination thereof. The wired interface, for example, may be an Ethernet interface. The Ethernet interface may be an optical interface, an electrical interface, or a combination thereof. The wireless interface, for example, may be a WLAN interface, a cellular network interface, or a combination thereof.

The processor 1002 may be a CPU.

The memory is configured to store a program, an instruction, and the like. Further, the program may include a program code, and the program code includes a computer operation instruction. The memory may include a RAM, or may include a non-volatile memory, for example, at least one magnetic memory. The processor 1002 executes the program, the instruction, and the like stored in the memory, to implement the functions of the server in the method embodiment of FIG. 2A and FIG. 2B.

The processor 1002 is configured to receive a first authentication request through the communications interface 1001, where the first authentication request is used to request to authenticate a terminal, send a first authentication success message through the communications interface 1001, and before receiving a response message that is sent by the authentication device for the first authentication success message, send an authentication success indication message to the terminal through the communications interface 1001.

For details, refer to the method embodiment of FIG. 2A and FIG. 2B, and details are not described in this application again.

According to the method provided in the embodiments of this application, the authentication device receives the network permission request packet sent by the terminal, and the authentication device grants the first network permission to the terminal. After granting the first network permission to the terminal, the authentication device receives the first authentication failure message sent by the server, and the authentication device withdraws the first network permission of the terminal based on the first authentication failure message. The first authentication failure message is sent when the server determines, based on the first authentication request message sent by the terminal, that the terminal fails to be authenticated. Therefore, the authentication device can grant the network permission to the terminal before receiving the authentication result sent by the server to avoid a long wait period of the terminal resulting from WAN instability, and can withdraw the network permission in time when receiving the first authentication failure message sent by the server.

According to the method provided in the embodiments of this application, the server receives the first authentication request, where the first authentication request is used to request to authenticate the terminal. The server sends the first authentication success message to the authentication device. Before receiving the response message that is sent by the authentication device for the first authentication success message, the server sends the authentication success indication message to the terminal. In the captive portal authentication scenario, after granting the network permission to the terminal, the authentication device sends the response message for the authentication success message to the server. After receiving the response message, the server sends the authentication success indication message to the terminal. A user learns, based on the authentication success indication message received by the terminal, that the terminal is granted the network permission, and can access a network. In this application, the authentication device grants the first network permission to the terminal before receiving the first authentication success message. Therefore, when the terminal is authenticated, the server directly sends the authentication success indication to the terminal without waiting for the response message that is sent by the authentication device for the first authentication success message. This can avoid an excessively long wait period of the terminal and poor user experience caused when the response message for the authentication success message is lost, and shorten the wait period of the terminal.

A person skilled in the art should understand that the embodiments of this application may be provided as a method, a system, or a computer program product. Therefore, the embodiments of this application may use a form of hardware only embodiments, software only embodiments, or embodiments with a combination of software and hardware. Moreover, the embodiments of this application may use a form of a computer program product that is implemented on one or more computer-usable storage media (including but not limited to a disk memory, and an optical memory) that include computer-usable program code.

The embodiments of this application are described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine such that the instructions executed by a computer or a processor of any other programmable data processing device generate an apparatus for implementing a specific function in one or more processes in the flowcharts and/or in one or more blocks in the block diagrams.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for granting network permission to a terminal, wherein the method is implemented by an authentication device, and wherein the method comprises:
receiving a network permission request packet from the terminal;
granting, in response to the network permission request packet, a first network permission to the terminal;
receiving a first authentication failure message from a server after granting the first network permission to the terminal, wherein the first authentication failure message is received when the server determines, based on a first authentication request message sent by the terminal, that the terminal fails to be authenticated; and
withdrawing the first network permission based on the first authentication failure message.

2. The method of claim 1, wherein after granting the first network permission, the method further comprises:
receiving a first authentication success message from the server, wherein the first authentication success message is received when the server determines, based on the first authentication request message sent by the terminal, that the terminal is authenticated, wherein the first authentication success message instructs the authentication device to grant a second network permission to the terminal, and wherein the second network permission is broader than the first network permission; and
granting the second network permission to the terminal based on the first authentication success message.

3. The method of claim 1, wherein the network permission request packet is a network access packet, wherein a source media access control (MAC) address in the network access packet is a MAC address of the terminal, and wherein before granting the first network permission to the terminal, the method further comprises:
sending the MAC address of the terminal to the server; and
receiving a second authentication success message from the server, wherein the second authentication success message is based on the MAC address of the terminal and reputation data of the terminal, and wherein the second authentication success message instructs the authentication device to grant the first network permission to the terminal.

4. A method for granting network permission to a terminal, wherein the method is implemented by a server, and wherein the method comprises:
receiving a first authentication request, wherein the first authentication request requests to authenticate the terminal;
sending, in response to the first authentication request, a first authentication success message to art authentication device; and
sending an authentication success indication message to the terminal before receiving a response message from the authentication device for the first authentication success message.

5. The method of claim 4, further comprising:
receiving a media access control (MAC) address of the terminal from the authentication device;
determining a second authentication success message based on the MAC address of the terminal and reputation data of the terminal, wherein the second authentication success message instructs the authentication device to grant a first network permission to the terminal; and
sending the second authentication success message to the authentication device.

6. An authentication device, comprising:
a communications interface; and
a processor is coupled to the communications interface and configured to:
receive, through the communications interface, a network permission request packet from a terminal;
grant a first network permission to the terminal;
receive, through the communications interface, a first authentication failure message sent from a server after granting the first network permission to the terminal, wherein the first authentication failure message is received when the server determines, based on a first authentication request message sent by the terminal, that the terminal fails to be authenticated; and
withdraw the first network permission based on the first authentication failure message.

7. The authentication device of claim 6, wherein the processor is further configured to:
receive, through the communications interface, a first authentication success message from the server after granting the first network permission to the terminal, wherein the first authentication success message is received when the server determines, based on the first authentication request message sent by the terminal, that the terminal is authenticated, wherein the first authentication success message instructs the authentication device to grant a second network permission to the terminal, and wherein the second network permission is broader than the first network permission; and
grant the second network permission to the terminal based on the first authentication success message.

8. The authentication device of claim 6, wherein the network permission request packet is a network access packet, wherein a source Media Access Control (MAC) address in the network access packet is a MAC address of the terminal, and wherein the processor is further configured to:
send the MAC address of the terminal to the server through the communications interface before granting the first network permission to the terminal; and
receive, through the communications interface, a second authentication success message from the server, wherein the second authentication success message is based on the MAC address of the terminal and reputation data of the terminal, and wherein the second authentication success message instructs the processor to grant the first network permission to the terminal.

9. A server, comprising:
a communications interface; and
a processor is coupled to the communications interface and configured to:
receive a first authentication request through the communications interface, wherein the first authentication request requests to authenticate a terminal;
send a first authentication success message through the communications interface to an authentication device; and
send an authentication success indication message to the terminal through the communications interface before receiving, through the communications interface, a response message from the authentication device for the first authentication success message.

10. The server of claim 9, wherein the processor is further configured to:
receive, through the communications interface, a Media Access Control (MAC) address of the terminal from the authentication device;
determine a second authentication success message based on the MAC address of the terminal and reputation data of the terminal, wherein the second authentication success message instructs the authentication device to grant a first network permission to the terminal; and
send the second authentication success message to the authentication device through the communications interface.

11. The method of claim 3, wherein the network access packet is a Hyper Text Transfer Protocol (HTTP)/HTTP Secure (HTTPS) packet.

12. The method of claim 3, wherein the network access packet is an Internet Protocol (IP) packet.

13. The method of claim 3, wherein the second authentication success message comprises an identifier of the first network permission.

14. The method of claim 1, wherein the first network permission is a temporary network permission comprising a time limit.

15. The method of claim 5, wherein the first network permission is a temporary network permission comprising a time limit.

16. The authentication device of claim 8, wherein the network access packet is a Hyper Text Transfer Protocol (HTTP)/HTTP Secure (HTTPS) packet.

17. The authentication device of claim 8, wherein the network access packet is an Internet Protocol (IP) packet.

18. The authentication device of claim 8, wherein the second authentication success message comprises an identifier of the first network permission.

19. The authentication device of claim 6, wherein the first network permission is a temporary network permission comprising a time limit.

20. The server of claim 10, wherein the first network permission is a temporary network permission comprising a time limit.
